(19) United States
(12) Patent Application Publication
(10) Pub. No.: US 2007/0051531 A1
(43) Pub. Date: Mar. 8, 2007

(54) Drug eluting coatings for a medical lead and method therefor

(76) Inventors: Harshad Borgaonkar, Blaine, MN (US); Daniel J. Cooke, Roseville, MN (US); Ronald W. Heil JR., Roseville, MN (US); Darren Kirby, Tipperary (IE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/221,588

(22) Filed: Sep. 8, 2005

(51) Int. Cl. H01B 5/00; B05D 3/00

(52) U.S. Cl. 174/126.1; 427/2.1

(57) ABSTRACT

A medical lead including a lead body extending from a first end portion to a second end portion and a coating disposed along a portion of the lead, wherein the coating includes at least one matrix polymer layer, at least one anti-inflammatory agent and at least one anti-proliferative agent.

### TECHNICAL FIELD

This invention relates to the field of medical leads, and more specifically to leads with therapeutic agent eluting coatings.

### BACKGROUND OF THE INVENTION

Leads having electrodes implanted in or about the heart have been used to reverse life-threatening arrhythmia or to stimulate contraction of the heart. Electrical energy is applied to the heart via an electrode to return the heart to normal rhythm. Leads are usually positioned on or in the ventricle or the atrium and the lead terminals are attached to a pacemaker or defibrillator which is implanted subcutaneously.

An issue concerning, for example, pacemaker leads is the increase in stimulation threshold, both acute and chronic, caused by the interaction between the electrode and body tissue at the point of implant. Approaches to reducing the threshold include silicone rubber based drug collars or plugs containing dexamethasone. However, in both cases, the lead design needs to accommodate the physical size of the plug or collar matrix. Also, dexamethasone is not very potent. Hence, high dosing is generally required. Moreover, these devices fail to address many of the physiological processes involved in the healing response upon lead implantation. Thus, there is a need for leads and/or electrodes that are constructed to more fully address the healing process so as to maintain optimal acute and chronic thresholds.

### SUMMARY OF THE INVENTION

One embodiment provides a medical lead including a lead body extending from a first end portion to a second end portion and a coating disposed along a portion of the lead, wherein the coating includes at least one matrix polymer layer, at least one anti-inflammatory agent and at least one anti-proliferative agent.

Another embodiment provides a medical lead including a lead body extending from a proximal end portion to a distal end portion; an electrode disposed along the lead body; and a coating associated with at least a portion of the electrode, wherein the coating includes a layer of phosphorylcholine (PC), polyvinylpyrrolidone (PVP), poly(vinyl alcohol) (PVA), hyaluranic acid (HA), polyactive or a combination thereof.

Another embodiment provides a method including coating a portion of a medical lead with at least one matrix polymer layer, at least one anti-inflammatory agent and at least one anti-proliferative agent; delivering the medical lead to a site of implantation; and releasing at least one anti-inflammatory agent and at least one anti-proliferative agent from the coating so as to decrease the formation of a fibrotic capsule near an electrode of an implanted lead.

### BRIEF DESCRIPTION OF THE DRAWINGS

FIG. 1 depicts a lead and pulse generator in accordance with at least one embodiment.

FIG. 2 depicts a portion of a lead with a coating in accordance with at least one embodiment.

FIG. 3 depicts a device to apply a coating or agent to a lead or electrode in accordance with one embodiment.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

The present device takes advantage of thin coatings of polymers and/or agents, such as therapeutic agents, applied to at least a portion of leads and/or electrodes. Thin coatings, instead of plugs and collars, reduce the polymer burden as well as allow for even distribution of agents, including high potency therapeutic agents, and/or polymers on leads and/or electrodes. Additionally, thin coatings allow for the creation of leads with smaller diameters (no longer necessary to accommodate the plug or collar). Thus, one embodiment provides for the combination of agents with downsized implantable devices. The coatings may also provide reduced acute and/or chronic pacing thresholds and/or increased lead sensitivity.

The term “lead” is used herein in its broadest sense and includes, but is not limited to, a stimulation lead, a sensing lead or a combination thereof. In one embodiment, the lead is adapted for active fixation. In another embodiment, the lead is adapted for passive fixation. In yet another embodiment, the lead is adapted for bipolar stimulation. In other embodiments, the lead is adapted for defibrillation and/or pacing/sensing. In one embodiment, the lead is tripolar or quadrupolar.

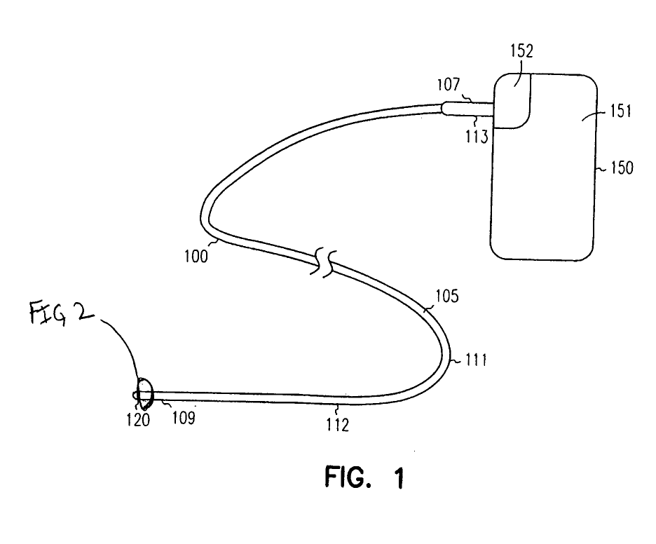

For example, FIG. 1 shows a view of a lead 100 coupled to a pulse generator 150. In one embodiment, lead 100 is adapted to deliver pacing energy to a heart. Some examples deliver defibrillation shocks to a heart. Pulse generator 150 can be implanted in a surgically-formed pocket in a patient's chest or other desired location. Pulse generator 150 generally includes electronic components to perform signal analysis, processing and control. Pulse generator 150 can include a power supply such as a battery, a capacitor and other components housed in a case or can 151. The device can include microprocessors to provide processing and evaluation to determine and deliver electrical shocks and pulses of different energy levels and timing for ventricular defibrillation, cardioversion and pacing to a heart in response to cardiac arrhythmia including fibrillation, tachycardia and bradycardia.

In one embodiment, lead 100 includes a lead body 105 extending from a proximal end 107 to a distal end 109 and having an intermediate portion 111. Lead 100 includes one or more conductors, such as coiled conductors or other conductors, to conduct energy from pulse generator 150 to an electrode 120, and also to receive signals from the heart. The lead further includes outer insulation 112 to insulate the conductor. The conductors are coupled to one or more electrodes, such as electrode 120. Lead terminal pins 113 are attached to pulse generator 150 at a header 152. The system can include a unipolar system with the case acting as an electrode or a bipolar system with a pulse between two distally located electrodes. In some examples, pulse generator can 151 can be used as an electrode. In some examples, a header electrode can be placed in or near the header 152 of can 151.

Lead Coatings

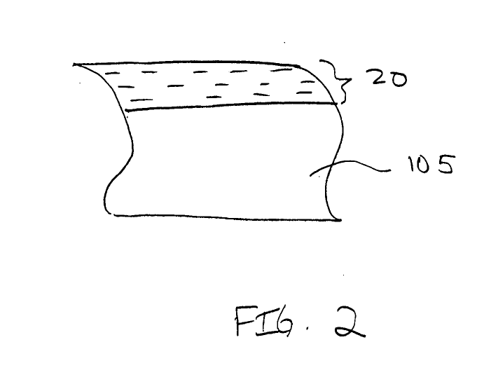

FIG. 2 depicts a coating 20 on a lead body 105 according to one embodiment. Generally, a coating 20 may include at least one of: a primer layer, a matrix polymer layer, which may include one or more agents admixed therein, a topcoat layer (e.g., a bio-beneficial topcoat), which may include one or more agents admixed therein, and/or one or more agents on a lead 100 and/or electrode 120. The one or more agents can elute through or from a layer or can be provided without a layer (admixed or layered on top).

A. Primer Layer

One embodiment provides a primer layer. The optional primer layer can be applied between the lead and another layer to improve the adhesion of the layer/coating 20 to the lead. The primer is applied to, for example, the surface of the lead and/or electrode prior to application of another layer, such as the matrix polymer layer, optionally admixed with one or more agent, the topcoat layer, optionally admixed with one or more agent and/or the agent(s).

Primers include, but are not limited to, medical adhesives, acrylics and surface modification of the lead surface (e.g., silicone) with plasma, such as oxygen plasma (which modifies the surface of, for example, polymers (e.g., silicon), so that they can adhere with other materials, such as other layers within the coating 20 or adhesives).

B. Matrix Polymer Layer

Another embodiment provides a matrix polymer layer. Polymers for use in the matrix polymer layer include, but are not limited to, Solef® (Solef® 21508 polymer; PVDF copolymer (VF₂-HFP) from Solvay, Brussels, Belgium), Room-Temperature-Vulcanizing (RTV) silicone elastomers, silicone (any of a group of semi-inorganic polymers based on the structural unit R₂SiO, where R is an organic group), ethylene vinyl alcohol (E/VAL; a thermoplastic polymer), polyethylene glycol (PEG), polycaprolactone, polylactide (PLA), polyglycolide (PGA), poly(lactide-co-glycolide) (PLGA) and/or polyurethane.

C. Topcoat Layer

Another embodiment provides a topcoat layer. Topcoat layers, such as bio-beneficial polymer topcoats, can be formed from compounds including, but not limited to, phosphorylcholine (PC), polyvinylpyrrolidone (PVP), poly(vinyl alcohol) (PVA), hyaluranic acid (HA), and/or polyactive (a block copolymer composed of polyethylene oxide (PEO) and polybutylene terpthalate (PBT)). In one embodiment, topcoats are mixed with other components, such as the polymer matrix components discussed above. In another embodiment, the topcoat layer is applied on top of a polymer or agent layer.

Topcoat layers are beneficial especially when used on an electrode 120. By coating the electrode 120 with a topcoat layer, the patient's immune system is exposed to an inert polymer and not the metal electrode 120. It is believed that a phosphorycholine (solution in EtOH) layer functions as an anti-macrophage adhesion surface, while a sodium hyaluronate (HA) layer functions as an anti-platelet adhesion surface.

In one embodiment, the topcoat layer is a proliferative, including but not limited to, hydroxyapatite (HAp). Hydroxyapatite (HAp) may promote the growth of excitable myocardial cells at the site of electrical stimulation (e.g., electrode 120). Reduced voltage and pulse width would be needed to stimulate the excitable myocardial cells (the stimulus would not have to overcome the non-excitable fibrotic barrier). Reduced stimulation voltage and pulse width would also reduce polarization at the lead tip, which would result in a lower stimulation impedance, and reduced likelihood of falsely sensing after-potential as cardiac activity. Reduced polarization at the lead electrode 120 would also improve electro-chemical corrosion and reduce pacemaker battery consumption. In one embodiment, the topcoat layer is not a proliferative (e.g., HAp).

In one embodiment, the topcoat layer on at least a portion of the electrode 120 is bio-degradable (e.g., bio-dissolvable). Bio-degradable topcoat layers can be formed from such polymers including but not limited to HA, PVA and/or PVP. In one embodiment, at least a portion of the lead 100 is coated with a bio-degradable topcoat layer. In another embodiment, at least a portion of the lead 100 is coated with a polymer that is not bio-degradable.

D. Agents

One embodiment provides a drug eluting lead 100 which comprises at least one therapeutic agent. The therapeutic agent includes, but is not limited to an anti-inflammatory, anti-proliferative, anti-arrhythmic, anti-migratory, anti-neoplastic, antibiotic, anti-restenotic, anti-coagulation, anti-clotting (e.g., heparin, coumadin, aspirin), anti-thrombogenic or immunosuppressive agent, or an agent that promotes healing, such as a steroid (e.g., a glucocorticosteriod), and/or re-endothelialization or combinations thereof.

In essence, any drug or bioactive agent which can serve a useful therapeutic, prophylactic or even diagnostic function when released into a patient can be used. The agents may be used alone, in combinations of agents, admixed with a layer or applied on top of, underneath or between layers of the coating 20.

More specifically, the therapeutic agents may include, but are not limited to paclitaxel, clobetasol, rapamycin (sirolimus), everolimus, tacrolimus, actinomycin-D, dexamethasone (e.g., dexamethasone sodium phosphate or dexamethasone sodium acetate), mometasone furoate, vitamin E, mycophenolic acid, cyclosporins, beclomethasone (e.g., beclomethasone dipropionate anhydrous), their derivatives, analogs, salts or combinations thereof.

In one embodiment, a combination of an anti-proliferative (e.g., everolimus or paclitaxel) and an anti-inflammatory (e.g., dexamethasone, clobetasol or mometasone furoate) agent may be employed. In one embodiment, a combination of dexamethasone and everolimus is employed. In another embodiment, a combination of clobetasol and everolimus is employed. In yet another embodiment, a combination of dexamethasone and paclitaxel is employed. In another embodiment, a combination of clobetasol and paclitaxel is employed. In another embodiment, a combination of dexamethasone and sirolimus is employed. In one embodiment a combination of clobetasol and sirolimus is employed.

The therapeutic agent can be present in any effective amount. An “effective amount” generally means an amount which provides the desired local or systemic effect. For example, an effective dose is an amount sufficient to affect a beneficial or desired clinical result. The precise determination of what would be considered an effective dose may be based on factors individual to each patient, including their size and age. In one embodiment, the therapeutic agent is present in a concentration of less than about 100 μg/cm². For example, the agent may be present in a range of about 2 to about 10 μg/cm², about 10 to about 20 μg/cm², about 20 to about 30 μg/cm², about 30 to about 40 μg/cm², about 40 to about 50 μg/cm², about 50 to about 60 μg/cm², about 60 to about 70 μg/cm², about 70 to about 80 μg/cm², about 80 to about 90 μg/cm² and/or about 90 to about 100 μg/cm². The agents may also be present at a concentration of higher than about 100 μg/cm².

In one embodiment, the agent eluting leads can be delivered to a desired site within the patient's body. Once implanted, the therapeutic agent may elute from the surface of the implant and diffuse into the adjoining tissue. In this manner, the inflammatory process and/or other unwanted biological processes associated with implantation and the presence of the foreign object is suppressed (e.g., reduced inflammation and/or toxicity of inflammatory response). Additionally, the growth of non-excitable, connective tissue around the electrode (e.g., the capsule) is reduced (e.g., a reduction in fibrotic capsule thickness may be observed), and thus, the postoperative rise in the stimulation threshold lessens, a stable reduced threshold, both acute and chronic, is thereby provided. Additionally, the device and methods may prevent myocyte cell function impairment and/or necrosis around, near or on an electrode 120, which may further stabilize a reduced threshold.

In one embodiment, the therapeutic agent is available immediately after and/or during implantation (time of injury). In another embodiment, within a few days, such as about 1 to about 5 days, following implantation, the agent has nearly completely eluted. In another embodiment, the therapeutic agent elutes in a couple of hours to several days to several weeks (e.g., in about 1 to about 5 weeks). The therapeutic agent may also be designed to have longer eluting times, such as several months. Additionally, the lead may be designed so that one therapeutic agent is released at the time of implantation (time of injury), while another therapeutic agent releases more slowly, for example, over the course of about several weeks to about a month or two from the time of implantation. In one embodiment, the two therapeutic agents may be the same or different therapeutic agents.

Method of Manufacture

In one embodiment at least one agent, polymer and/or topcoat are admixed, for example, with a solvent to provide a solution or mixture. In one embodiment, the solvent does not interfere with the activity of the agent. Examples of such solvents include water, alcohol, cyclohexanone, acetone and combinations thereof. The solution can be applied to at least a portion or all of a lead 100 and/or electrode 120 by, for example, spray coating. After the solvent in the solution is evaporated, a thin layer containing at least one agent, polymer and/or topcoat remains on the surface of the lead 100 and/or electrode 120. The process can be repeated as many times as desired. Alternatively, the coating 20 can be applied to the lead 100 and/or electrode 120 by dip-coating. Brush-coating can also be used. RF magnetron physical vapor deposition sputtering process may also be employed. The coating 20 may also be applied using a combination of spraying, dipping, sputtering and/or brushing.

In one embodiment, a coating 20 comprising one or more layers ranges from about submicron to about 10 microns in thickness, about 1 to about 50 microns in thickness or about 50 to about 100 microns in thickness. In another embodiment, the thickness of the coating 20 ranges from about 1 to about 5, about 5 to about 10 microns, about 10 to about 15, about 15 to about 20, about 20 to about 30, about 30 to about 40, about 40 to about 50, about 50 to about 60, about 60 to about 70, about 70 to about 80, about 80 to about 90, or about 90 to about 100. In one embodiment, one or more layers are distributed evenly across a distal portion of a lead 100 and/or electrode 120. In one embodiment, one or more layers are applied to the lead body 100 adjacent to the electrode 120.

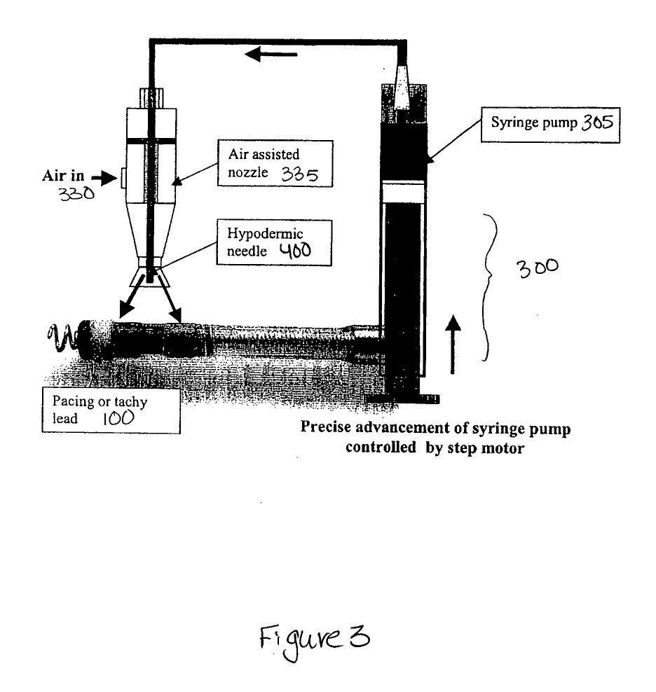

FIG. 3 depicts a device that may be used to apply primer, polymer matrix layer, with or without one or more agent admixed therein, topcoat layer, with or without one or more agent admixed therein, and/or an agent to at least a portion of a lead and/or an electrode. A syringe, typically a motorized syringe 300 (filled with one or more agent, polymer and/or topcoat, or a mixture thereof in solution or as a mixture in solvent) mounted on a syringe pump 305 (e.g., a positive displacement pump that can accurately meter fluid, the advancement of which is controlled by a motor, such as a step motor) is connected to a hypodermic needle based nozzle assembly 400. The fluid dispensed from the needle can either be atomized to spray using pressured air (air inlet 330) on the nozzle 335 or just droplets without using pressured air for coating at least a portion of the lead and/or electrode. The lead can be rotated during this process so that all sides of the device are coated.

For example, one embodiment provides a coating comprising a mixture of everolimus, clobetasol and Solef® from solution in acetone or acetone and cyclohexanone solvents for application to the electrically inactive surfaces of the lead close (e.g., proximal) to the electrode using spray and/or drop coating methods, optionally followed by a topcoat layer applied, for example, by the spray coating process.

This process of spray coating allows for greater control of coating placement which thereby allows for more accurate placement so as to selectively coat one area of the lead and/or electrode without contaminating other areas of the lead and/or electrode with the spray solution/mixture. Other benefits of the spray coating method are decreased waste of coating solution/mixture and uniform coating on the device (e.g., along a lead body or on an electrode). A uniform thickness and precise quantity will lead to uniform and consistent eluting of agent from the coated device surface.

Additionally, the coating of at least a portion of the lead 100 and/or the electrode 120 allows for therapeutic agent to be provided to the injured tissue from a large surface area. Furthermore, thin coatings and potent (chemically or medicinally effective) therapeutic agents provide for reduced polymer and therapeutic agent burden on the lead 100 and/or electrode 120, making it possible to reduce the lead 100 diameter. For example, therapeutic agents such as clobetasol and everolimus can be used at low doses, such as about 100 μg/cm² (much lower than that used for dexamethasone in lead collars and plugs) and be highly effective.

Any combination of layers (primer, polymer matrix layer, topcoat layer) and/or agents is envisioned; additionally the various components (primer, polymer matrix layer, topcoat layer, and/or agents) may be embedded within the lead. In one embodiment, the one or more layers and/or agent(s) are disposed on at least a portion of the lead 100 adjacent to the electrode 120. For example, in one embodiment, the agent(s) and/or layers(s) are applied directly to at least a portion of the lead 100 and/or electrode 120. In one embodiment, at least a portion of the lead 100 and/or electrode 120 is coated with a primer. In another embodiment, at least a portion of the lead 100 is coated with primer layer and/or a polymer matrix layer. In another embodiment, at least a portion of the lead 100 is coated with primer, matrix polymer layer and/or a topcoat layer. In another embodiment, at least a portion of the lead 100 is coated with matrix polymer layer. In another embodiment, at least a portion of the lead 100 is coated with a matrix polymer layer and/or a topcoat layer. In another embodiment, at least a portion of the lead 100 and/or electrode 120 are coated with topcoat layer. In another embodiment, at least a portion of the lead 100 and/or electrode 120 are coated with agent (e.g., therapeutic agent or drug).

In one embodiment, one or more agents are applied directly onto at least a portion of the lead 100 and/or the electrode 120. In another embodiment, one or more agents are applied on top of a primer, polymer matrix layer and/or a topcoat layer. In another embodiment, one or more agents are admixed with the polymer matrix layer and/or the topcoat layer (e.g., prior to application of the layer). In another embodiment, one or more agents are applied between two or more layers of matrix polymer and/or two or more layers of topcoat. The agents admixed in the layers and/or applied on top of or between the layers can be the same or different. For example, in one embodiment, the agent admixed with the polymer matrix layer is different from the agent admixed in the topcoat layer.

One embodiment provides a polymer matrix layer applied alone to at least a portion of the lead 100, applied after a primer, applied after an agent, and/or admixed with one or more agents, and/or followed by another layer of polymer matrix and/or a topcoat layer or agent. Another embodiment provides a bio-beneficial topcoat over one or a mixture of anti-inflammatory and anti-proliferative agents, including dexamethasone, such as dexamethasone acetate, cloebasol and everolimus in a polymer matrix. Another embodiment provides a lead 100 comprising a bio-beneficial polymer topcoat over a drug eluting polymer matrix layer comprising clobetasol and/or everolimus in Solef®. Such a combination will give an anti-thrombogenic surface and will result in moderate and controlled acute inflammatory response.

In one embodiment, a topcoat is admixed with one or more agents or the agent is applied before or after the topcoat or in between two layers of topcoat. The topcoat can be applied directly to at least a portion of the lead 100 and/or electrode 120. A topcoat can also be applied to the polymer matrix layer, mixed with the polymer matrix layer, or on top of another topcoat layer.

In addition to the agent and/or layers/coatings 20 being deposited on the surface of at least a portion of the electrode 120, the agent may be deposited within interstices of a porous electrode (e.g., a porous platinum electrode) and/or other types of depressions (e.g., channels, grooves, bore holes) of the electrode. As a result of the addition of structure to the electrode, an increased amount of agent, primer, polymer matrix and/or topcoat may be deposited. The primer, polymer matrix, topcoat and/or agent may be applied into channels via an inkjet device or the syringe/needle apparatus depicted in FIG. 3 or any other methods described herein.

In one embodiment, the agent, primer, polymer matrix and/or topcoat are applied to at least a portion of an electrode 120 which contacts tissue when implanted. In one embodiment, the coatings 20 and/or agent(s) do not impede the function of the lead 100 and/or electrode 120 (e.g., the electrode 120 can pace through the coating 20 and/or agent(s)). In one embodiment, the agent, primer, polymer matrix and/or topcoat are applied to at least a portion of a lead 100 and to at least a portion of an electrode 120.

Additionally, the primer, matrix polymer, topcoat and/or agent can be combined, cast into films and mounted on a lead 100 as a drug collar or formed into a polymer plug. For example, an electrode, such as a Fineline electrode tip (a cathode comprised of crenulated dome having a surface of polished platinum, platinum black, platinum/iridium, iridium oxide, titanium nitride, or other suitable electrode material), can be formulated so as to comprise a polymer plug of, for example, one or more agents and at least one polymer or topcoat. In one embodiment, the agents comprise a steroid and everolimus. In another embodiment, the therapeutic agent comprises everolimus. In one embodiment, the agent and polymer are admixed; in another embodiment, they are layered. The plug can be pre-made and inserted in the electrode or can be deposited in the space using syringe technology.

In one embodiment, dexamethasone (e.g., DSP or DA) and an anti-proliferative agent, such as everolimus, is delivered through a silicone collar and/or plug. In another embodiment, sodium hyaluronate (HA) is used as a drug delivery vehicle for anti-inflammatory and/or anti-proliferative agents in a plug and/or collar. In one embodiment, at least a portion of a lead helix, lead and/or electrode is coated with a mixture of HA and PC or a layer of PC followed by a layer of HA. Another embodiment provides a plug comprising a mixture of HA/PC/everolimus/DA. Another embodiment provides a collar comprising a mixture of HA/PC/everolimus/DA coated with layers of HA and PC.

As used herein, a coating associated with an electrode includes but is not limited to a layer on the surface of the electrode; components described herein may be within interstices of a porous electrode (e.g., a porous platinum electrode) and/or other types of depressions (e.g., channels, grooves, bore holes) of the electrode, and drug plugs.

The coating 20, which comprises one or more layers, is useful on any medical lead. For example, any medical implantable lead including, but not limited to, right-sided and left-sided cardiac leads, positive fixation leads where therapeutic agent is positioned at the fixation mechanism, positive fixation leads where therapeutic agent is positioned at the fixation mechanism that includes an electrode helix, epicardial leads that are sized for implantation through catheter delivery systems, downsized leads where coatings 20 are an option for positioning controlled release therapeutic agent delivery technology, neuro-stimulation leads requiring precise placement of electrode/therapeutic agent releasing components, miniaturized electrodes where coatings 20 can mask to produce high impedance and release agents, and miniaturized leads where a plurality of electrodes can be produced at specific locations by coating/masking.

All publications, patents and patent applications are incorporated herein by reference. It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

1. A medical lead comprising:
a lead body extending from a first end portion to a second end portion; and
a coating disposed along a portion of the lead, wherein the coating includes at least one matrix polymer layer, at least one anti-inflammatory agent and at least one anti-proliferative agent.

2. The lead of claim 1, wherein the coating is adjacent to at least one electrode.

3. The lead of claim 1, wherein the coating is about 5 to about 10 microns thick.

4. The lead of claim 1, wherein the coating is about 1 to about 50 microns thick.

5. The lead of claim 1, wherein the matrix polymer comprises polyvinylidene fluoride, room-temperature-vulcanizing silicone elastomers, silicone, ethylene vinyl alcohol (ENAL), polyethylene glycol (PEG), polycaprolactone, polylactide, polyglycolide, polyurethane or a combination thereof.

6. The lead of claim 1, wherein the polymer comprises polyvinylidene fluoride copolymer.

7. The lead of claim 1, wherein the anti-inflammatory agent comprises a steroid.

8. The lead of claim 7, wherein the steroid comprises clobetasol, dexamethasone, beclamethasone their derivatives, analogs, salts or a combination thereof.

9. The lead of claim 1, wherein the anti-proliferative agent comprises paclitaxel, rapamycin, everolimus, tacrolimus, actinomycin-D, their derivatives, analogs, salts or a combination thereof.

10. The lead of claim 1, wherein the anti-inflammatory agent comprises dexamethasone or clobetasol.

11. The lead of claim 1, wherein the anti-proliferative agent comprises paclitaxel, rapamcyin or everolimus.

12. The lead of claim 1, further comprising a primer layer on at least a portion of a surface of the lead.

13. The lead of claim 1, further comprising at least one topcoat layer selected from the group consisting of phosphorylcholine (PC), polyvinylpyrrolidone (PVP), poly(vinyl alcohol) (PVA), hyaluranic acid (HA), polyactive, or a combination thereof.

14. The lead of claim 1, further comprising hydroxyapatite (HAp).

15. The lead of claim 13, wherein the topcoat layer comprises at least one additional agent that is a therapeutic agent.

16. A medical lead comprising:
a lead body extending from a proximal end portion to a distal end portion;
an electrode disposed along the lead body; and
a coating associated with at least a portion of the electrode,
wherein the coating includes a layer of phosphorylcholine (PC), polyvinylpyrrolidone (PVP), poly(vinyl alcohol) (PVA), hyaluranic acid (HA), polyactive or a combination thereof.

17. The lead of claim 16, further comprising at least one therapeutic agent mixed in the coating.

18. The lead of claim 16, further comprising at least one therapeutic agent layered on top of or under the layer associated with the electrode.

19. The lead of claim 16, further comprising hydroxyapatite (HAp).

20. The lead of claim 19, further comprising a second layer selected from the group consisting of phosphorylcholine (PC), polyvinylpyrrolidone (PVP), poly(vinyl alcohol) (PVA), hyaluranic acid (HA), polyactive or a combination thereof.

21. The lead of claim 20, wherein at least one therapeutic agent is between the first and second layers, mixed in at least one layer, or a combination thereof.

22. The lead of claim 17, wherein the therapeutic agent comprises an anti-inflammatory agent, anti-proliferative agent, anti-arrhythmic agent, anti-migratory agent, anti-neoplastic agent, antibiotic agent, anti-restenotic agent, anti-coagulation agent, anti-clotting agent, anti-thrombogenic agent, immunosuppressive agent, steroid or a combination thereof.

23. The lead of claim 17, wherein the therapeutic agent comprises paclitaxel, clobetasole, rapamycin, everolimus, tacrolimus, actinomycin-D, dexamethasone, vitamin E, mycophenolic acid, cyclosporin, beclomethasone their derivatives, analogs, salts or a combination thereof.

24. A method comprising:
coating a portion of a medical lead with at least one matrix polymer layer, at least one anti-inflammatory agent and at least one anti-proliferative agent;
delivering the medical lead to a site of implantation; and
releasing at least one anti-inflammatory agent and at least one anti-proliferative agent from the coating so as to decrease the formation of a fibrotic capsule near an electrode of an implanted lead.
